(19) United States
(12) Patent Application Publication
(10) Pub. No.: US 2011/0277273 A1
(43) Pub. Date: Nov. 17, 2011

(54) HINGE PART FOR THE HINGE OF A FLAP, ENGINE BONNET OR BOOT LID OF A MOTOR VEHICLE, AND HINGE

(75) Inventors: Udo MILDNER, Limburg (DE); Lothar TESKE, Aschaffenburg (DE); Joachim LIEBERS, Mammenheim (DE)

(73) Assignee: GM GLOBAL TECHNOLOGY OPERATIONS LLC, Detroit, MI (US)

(21) Appl. No.: 13/099,915

(22) Filed: May 3, 2011

(30) Foreign Application Priority Data
May 15, 2010 (DE) 102010020650.4

(51) Int. Cl. E05D 11/00

(52) U.S. Cl. 16/251; 16/250

(57) ABSTRACT

A hinge part is provided for the hinge of a flap, engine bonnet or boot lid of a motor vehicle. Provision is made that the hinge part has at least one section embodied in a hybrid construction, which is constructed as an open profile and the opening of which is closed at least partially by at least one cover part. A hinge is also provided for a flap, engine bonnet or boot lid of a motor vehicle.

### CROSS-REFERENCE TO RELATED APPLICATION

This application claims priority to German Patent Application No. 102010020650.4, filed May 15, 2010, which is incorporated herein by reference in its entirety.

### TECHNICAL FIELD

The technical field relates to a hinge part for the hinge of a flap, engine bonnet or boot lid of a motor vehicle. The technical field further relates to a hinge for a flap, engine bonnet or boot lid of a motor vehicle.

### BACKGROUND

A typical case of application for a hinge of the type mentioned here is to hold the boot lid of a vehicle swivellably on the body of the latter. The boot lid is actually, however, frequently stressed on one side when being closed by a person, by the person simply pushing laterally onto the boot lid. By this lateral actuation, the hinge is stressed in the transverse direction of the vehicle, so that an enormous torsional and bending stress is produced. The result is that in the closing process, the boot lid frequently comes in contact with the body of the motor vehicle and thereby damage to the paint results on the boot lid and the body. In order to also be able to close the boot lid in a contact-free manner with stressing from one side, a hinge construction with a high rigidity is therefore usually aimed for. A high rigidity of the hinge is usually achieved by a tubular construction of the hinge parts. As metallic tubular profiles are usually utilized for this, the hinge parts have a relatively great weight.

In view of the foregoing, it is desirable to provide a hinge part having the features mentioned in the introduction, which is relatively light in weight and in addition has a sufficiently high rigidity. In addition, a corresponding hinge is to be proposed. In addition, other desirable features and characteristics will become apparent from the subsequent summary and detailed description, and the appended claims, taken in conjunction with the accompanying drawings and this background.

### SUMMARY

The hinge part according to an embodiment is suitable for the hinge of a flap, engine bonnet or boot lid of a motor vehicle. Provision is made that the hinge part has at least one section embodied in a hybrid construction, which is constructed as an open profile and the opening of which is at least partially closed by at least one cover part.

By the construction of the at least one section of the hinge part in a hybrid construction, the hinge part is relatively light in weight. A hybrid construction is to be understood here to mean that the component which is embodied in a hybrid construction is produced from a combination of plastic and metal. By the at least one section being covered at least partially by at least one cover part, so that the open profile of the section is closed, the hinge part has, furthermore, a sufficiently high rigidity. A deforming of the flap, engine bonnet or boot lid of a motor vehicle in the case of lateral actuation on one side can thereby be largely or entirely prevented, so that in the closing process any damage to the paint of the flap, engine bonnet or boot lid by friction on the body is prevented. The measure according to the invention therefore leads to a construction of the hinge part which light in weight, with at the same time a sufficiently high rigidity.

A hinge part that is particularly light in weight is realized according to an embodiment of the invention when the cover part is a plastic component or respectively consists substantially of plastic. An increased rigidity of the hinge part is realized according to another embodiment when the cover part is a hybrid component. By the additional metallic component of the cover part, an increased rigidity is produced compared with the cover part consisting purely of plastic.

It lends itself for the cover part to be formed from solid material. Thereby, the cover part is given a further improvement to its rigidity. It is, in addition, particularly robust and durable. In addition, it lends itself for the cover part to have at least one or several openings, in particular punched out portions. Thereby, a saving on material is the result, whereby the cover part can be embodied so as to be relatively light.

According to a further embodiment, provision is made that the section, which is constructed as an open profile, has a collar against which the cover part lies. Thereby, an optimum connection is made possible of the cover part to the section which is constructed as an open profile. On grounds of manufacturing technology, it lends itself for the collar to project outwards. Of course, provision can also be made that the collar is directed inwards into the interior of the open profile. In addition, it lends itself for the section to be coated with plastic on the outer surface of its collar. A flat or planar contact surface for the cover part can thereby be formed in a particularly simple manner. It also lends itself for the cover part to be securely connected with the section which is constructed as an open profile. Thereby, a hinge part having a high rigidity is permanently realized.

The cover part is preferably connected with the section by means of welding and/or gluing. Thereby, an inseparable connection of cover part and section is formed. It may also be the case that the section and the cover part are detachably connected with each other. The cover part and/or the at least one section which is constructed as an open profile should preferably have a sheet metal structure which is at least partially surrounded by a plastic structure. By the sheet metal structure, the hinge part is able to be deformed well and in this respect is able to be transferred optimally into any desired geometry. The plastic can be injected onto the sheet metal structure or respectively the sheet metal structure can be injected around with plastic. The use of an injection molding method lends itself preferably here.

With regard to the cover part, it is conceivable that it is completely surrounded by a plastic layer. It may also be the case that the cover part has an additional surrounding injection of plastic at its edges. The edges which are injected around should preferably be connected with each other by means of webs. Thereby, an additional reinforcement of the cover part is produced. Also, by means of the webs on injection molding an optimum material flow to the edges is made possible.

According to a further embodiment, provision is made that the section which is constructed as an open profile has a rib structure in its interior. This measure also aims to reinforce the hinge part. The rib structure should preferably consist of plastic. Thereby, the rib structure is given, on the one hand, a reinforcing effect with regard to the hinge part. Due to the plastic, the rib structure is, moreover, relatively light in weight.

According to a further embodiment, provision is made that at least a portion of the edges of the section which is constructed as an open profile is surrounded by a plastic structure, in particular is injected around with plastic. Thereby, the cut edges of the section are injected around with plastic, so that a risk of injury due to possible sharp edges of the hinge part is prevented.

In a further embodiment, connecting webs are provided, by which the rib structure and the plastic structure are connected with each other, in particular are connected in one piece with each other. By the connecting webs, an improvement is brought about of the material flow in the injection molding tool during the production of the plastic structure for the hinge part. The connecting webs also serve to reinforce the hinge part.

According to a further embodiment, provision is made that at least one retaining element for coupling with other functional parts is formed on the plastic structure of the section and/or on the plastic structure of the cover part. Such a retaining element can be realized in a simple and favorably priced manner, because it can be formed or is formed together with the hinge part. The measure of forming at least one groove, channel or suchlike mount for a cable or a cable set on the plastic structure of the section and/or on the plastic structure of the cover part, aims in the same direction.

Another embodiment is that the mount for a cable or a cable set is formed on a section of the cover part extending laterally toward the exterior. This laterally projecting section or respectively region of the cover part is able to be produced simply by means of injection molding and offers an optimum protection for the cable or respectively the cable set.

Another embodiment is that a wall section of the mount has a detent nose, clip or suchlike positive-fitting elements, by means of which the cable or the cable set is held against the edge of the section which is constructed as an open profile, with the formation of a clamping connection. The cable or respectively the cable set is thereby fixed in the mount, preferably is held in a positive-fitting manner. Rattling noises by the cable or respectively the cable set whilst the vehicle is travelling are thereby effectively prevented.

According to an embodiment, provision is made that the at least one section which is constructed as an open profile is constructed so as to be U-shaped or V-shaped in cross-section. Such cross-sectional shapes are able to be realized simply and at a favorable cost.

According to a further embodiment, several sections are provided which are constructed as an open profile. By being in several parts, the hinge part is able to be realized flexibly in any desired geometries, simply and at a favorable cost. The hinge part should preferably consist of three sections with a central section and two end sections, wherein the central section is constructed in a bow shape and the one end section is formed in the manner of a hinge arm, which is suited for example for connection to a boot lid. The other end section preferably has a mount, in order to be rotatably coupled with a second hinge part. The several sections which are constructed as an open profile are preferably connected securely with each other by means of welding, riveting and/or clinching. The hinge part can be used both as a right-hand part and also as a left-hand part.

According to another embodiment, a hinge is provided for a flap, engine bonnet or boot lid of a motor vehicle. The hinge has at least one hinge part of the type described above.

### BRIEF DESCRIPTION OF THE DRAWINGS

The present invention will hereinafter be described in conjunction with the following drawing figures, wherein like numerals denote like elements, and:

FIG. 1 is an embodiment of a hinge part for the hinge of a flap, engine bonnet or boot lid of a motor vehicle, in perspective view;

FIG. 2 is the hinge part according to FIG. 1 in another perspective view;

FIG. 3 is the hinge part according to FIG. 1 without its cover part, in front view;

FIG. 4 is the cover part of the hinge part according to FIG. 1, in perspective view;

FIG. 5 is the hinge part according to FIG. 1 in a further perspective view; and

FIG. 6 is the hinge part according to FIG. 1 in section through the section line A-A according to FIG. 5.

### DETAILED DESCRIPTION

The following detailed description is merely exemplary in nature and is not intended to limit application and uses. Furthermore, there is no intention to be bound by any theory presented in the preceding background or summary or the following detailed description.

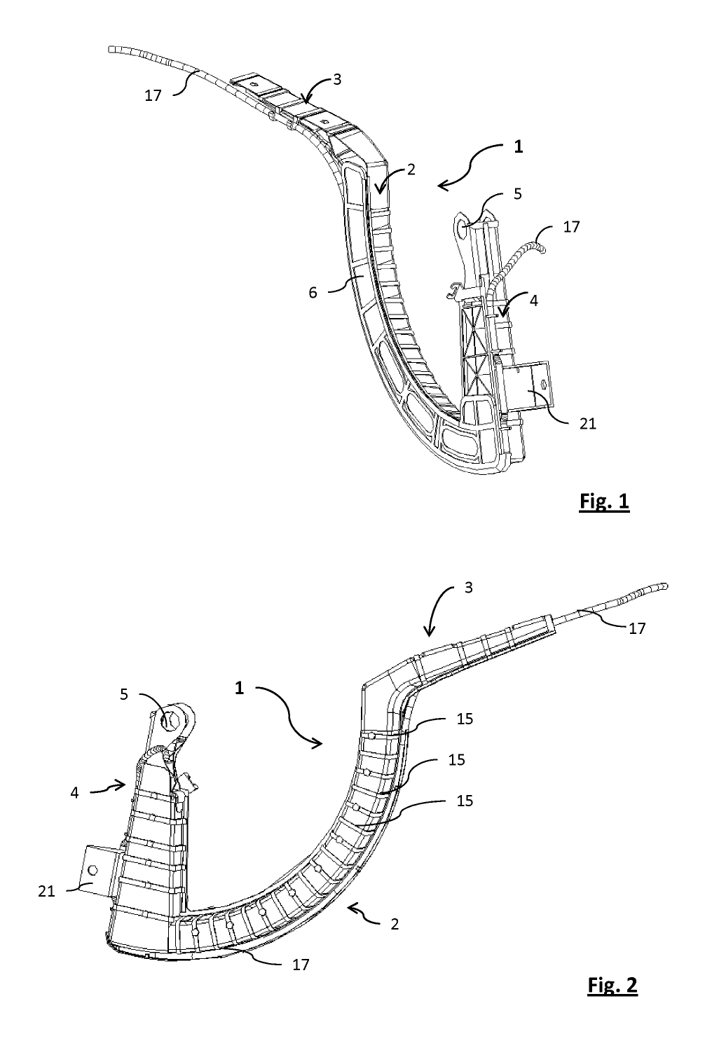

FIG. 1 and FIG. 2 show—in diagrammatic illustration—a possible embodiment of a hinge part 1, which is suitable for a hinge of a flap, engine bonnet or boot lid of a motor vehicle. The hinge part 1 according to FIG. 1 is preferably used in a hinge of a boot lid. The hinge part 1 has at least three sections, namely two end sections 3, 4 and a section 2 lying therebetween. The section 2 lying therebetween is preferably constructed in a bow shape. Adjoining hereto at its one free end is the one end section 3, which is preferably constructed in the manner of an arm and serves for connection to a boot lid. The other end section 4 adjoins the other free end of the section 2 and has at its one end a mount 5 for a further hinge part (not illustrated). The hinge part 1 is able to be mounted by the mount 5 in a rotatably movable manner with the other hinge part (not illustrated).

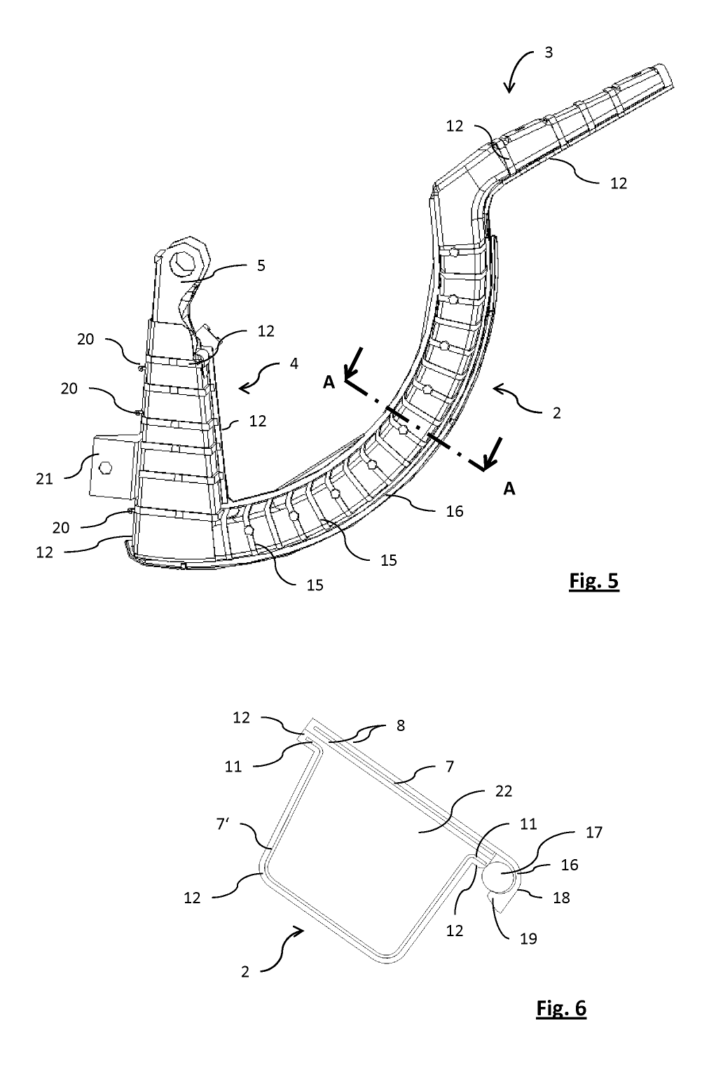

The section 2 and the two end sections 3 and 4 are preferably formed by separate parts, which are securely connected with each other by means of welding, riveting and/or clinching. The section 2 and the end sections 3 and 4 are embodied in a hybrid construction, i.e., they have a combination of metal structure 7′ and plastic structure 12, as can be seen in particular from FIG. 6. Through the hybrid construction, the hinge part 1 is relatively light in weight. The metal structure 7′ of the section 2 and of the end sections 3 and 4 is preferably constructed as sheet metal structure 7′, which is at least partially surrounded by the plastic structure 12.

As can be seen in particular from FIG. 6, at least the section 2 is constructed as an open profile, wherein the opening 22, formed by the open profile, of the section 2 is at least partially closed by a cover part 6. For this, the cover part 6 is preferably inseparably connected with the section 2, in particular connected by means of vibration welding and/or gluing. Owing to the partially closed construction of the open profile of the section 2, a relatively rigid structure is formed, which gives the entire hinge part 1 a relatively high rigidity.

The cover part 6 is preferably constructed in a hybrid construction and has a sheet metal structure 7, which is preferably provided on both sides with a plastic layer 8 or respectively plastic structure. The cover part 6 is preferably formed from solid material, wherein it may have at least one recess or respectively punched out portion 10.

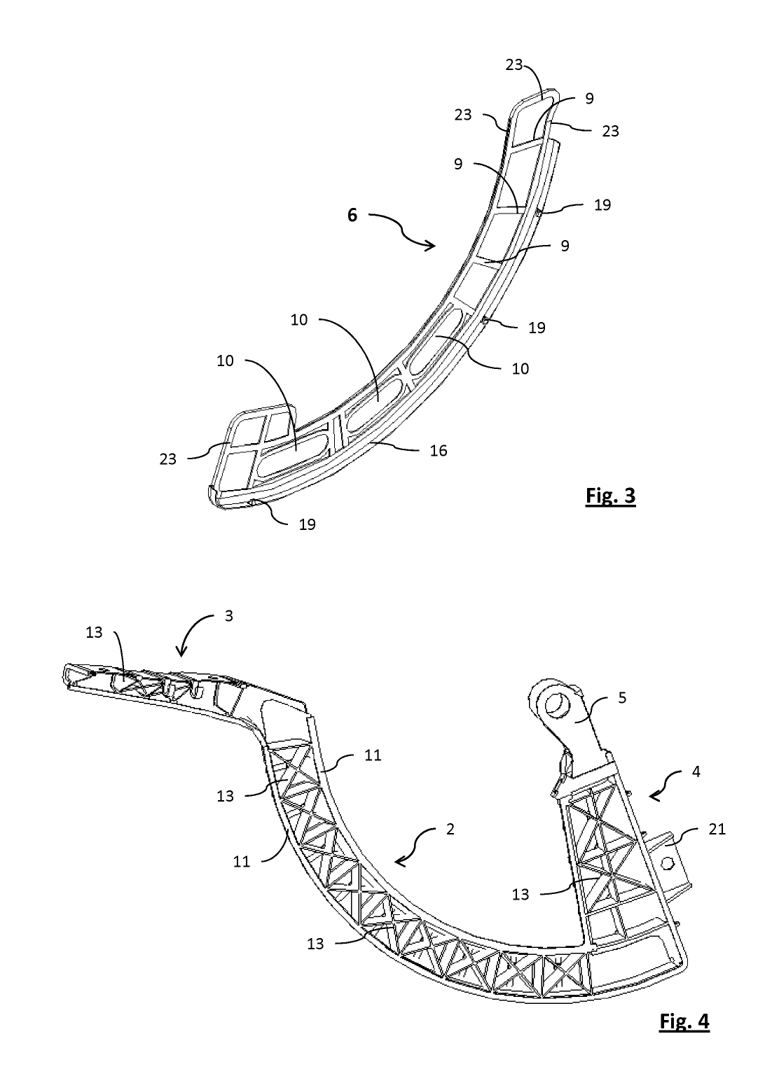

As can be seen in particular from FIG. 3, the cover part 6 is additionally injected around with plastic at least at its edges 23, with these surrounding injections with plastic being connected with each other via at least one web 9. The at least one web 9 is preferably realized by injection molding, so that the surrounding injections with plastic are additionally applied on the plastic structure 8.

As can be seen in particular from FIG. 6, at least the section 2 is preferably constructed substantially in a U-shape. In the present embodiment, the section 2 and the end sections 3 and 4 are constructed substantially in a U-shape.

The section 2 has in addition a collar 11, which extends toward the exterior and against which the cover part 6 lies. The region of the collar 11 of the section 2 is preferably provided with the plastic structure 12, so that a flat contact surface is formed by the plastic for the cover part 6.

As can be seen in particular from FIG. 4, the section 2 and the end sections 3 and 4 are provided in the interior of their profile with a rib structure 13, which is preferably formed from plastic. The section 2 and the end sections 3 and 4 are also injected around with plastic at their edges, so that the cut edges of the section 2 and of the end sections 3 and 4 are protected by the plastic coating. The plastic coating which is present at the edges of the section 2 and of the end sections 3 and 4 is connected via connecting webs 15 with the rib structure 13, so that a material flow from the edges of the section 2 and of the end sections 3, 4 towards the rib structure 13 is produced on casting of the plastic in the course of the manufacturing process.

As can be seen in particular from FIG. 3, FIG. 5 and FIG. 6, a mount 16 for a cable set 17 is formed on the cover part 6. The mount 16 is preferably constructed here in the manner of a groove, so that the cable set 17 can be laid therein. In order to hold the cable set 17 securely in the mount 16, a detent nose 19 is formed on a wall section 18 of the mount 16, which detent nose holds the cable set 17 against the edge of the section 2 with the formation of a clamping connection.

As can be seen in particular from FIG. 3, several of the detent noses 19 can be arranged along the mount 16, so that at the sites of the detent noses 19 respectively a clamping connection is brought about between detent nose 19, cable set 17 and the edge of the section 2.

As can be seen in particular from FIG. 5, fastening elements 20 can be formed on the connecting webs 15 or on any other desired regions of the plastic coating or of the plastic structure 12 of the section 2 and of the end sections 3 and 4. The fastening elements 20 can serve for example for the fastening of the cable set 17 in the region of the section 2 and of the end sections 3 and 4. The fastening elements 20 can be constructed as a detent nose, clip element or suchlike clamping element. In addition, further retaining elements for other functional parts can be provided on the connecting webs 15, the plastic structure 12 of the section 2 and/or the end sections 3, 4 or the plastic structure 8 of the cover part 6. For example, a retaining element 21 is formed on the end section 4. The retaining element 21 can serve as a fixture for a pressure spring (not illustrated) engaging on the hinge, for holding the boot lid open. The retaining element 21 can also serve as a fastening lug for cable sets or hose lines.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A hinge part for a hinge of a component of a motor vehicle, comprising:
a section embodied in a hybrid construction that is constructed with an opening; and
a cover part that is configured to at least partially cover the opening.

2. The hinge part according to claim 1, wherein the hinge is configured for use with a flap of the motor vehicle.

3. The hinge part according to claim 1, wherein the hinge is configured for use with an engine bonnet of the motor vehicle.

4. The hinge part according to claim 1, wherein the hinge is configured for use with a boot lid of the motor vehicle

5. The hinge part according to claim 1, wherein the cover part is a hybrid component.

6. The hinge part according to claim 1, wherein the section comprises a collar against which lays the cover part.

7. The hinge part according to claim 1, wherein the cover part is securely connected with the section.

8. The hinge part according to claim 1, wherein the cover part is securely connected with the section by welding.

9. The hinge part according to claim 1, wherein the cover part is securely connected with the section by gluing.

10. The hinge part according to claim 1, wherein the cover part comprises a sheet metal structure that is surrounded at least partially by a plastic structure.

11. The hinge part according to claim 1, wherein the section comprises a sheet metal structure that is surrounded at least partially by a plastic structure.

12. The hinge part according to claim 1, wherein the section comprises an interior rib structure.

13. The hinge part according to claim 12, wherein the interior rib structure is formed at least partially from plastic.

14. The hinge part according to claim 1, wherein at least a portion of edges of the section is surrounded by a plastic structure.

15. The hinge part according to claim 12, further comprising connecting webs connected to the interior rib structure.

16. The hinge part according to claim 1, further comprising a retaining element configured to couple with other functional parts and formed on a plastic structure of the section.

17. The hinge part according to claim 1, further comprising a groove on a plastic structure of the cover part that is configured to receive a cable.

18. The hinge part according to claim 17, wherein a wall section of a mount comprises a positive-fitting element by which the cable is held against an edge of the section.

19. The hinge part according to claim 1, wherein the section is U-shaped in cross-section.

20. The hinge part according to claim 1, wherein the section is V-shaped in cross-section.
